(19) United States
(12) Patent Application Publication
(10) Pub. No.: US 2026/0000999 A1
(43) Pub. Date: Jan. 1, 2026

(54) AUTOMATIC ENHANCEMENT OF HIGHLIHTS FOR CONTENT STREAMING SYSTEMS AND APPLICATIONS

(71) Applicant: NVIDIA Corporation, Santa Clara, CA (US)

(72) Inventors: Prabindh Sundareson, Bangalore (IN); Shyam Raikar, Pune (IN)

(21) Appl. No.: 18/757,987

(22) Filed: Jun. 28, 2024

(51) Int. Cl. A63F 13/86; A63F 13/52; A63F 13/533; A63F 13/77; G06T 5/70; G06V 20/40

(52) U.S. Cl. CPC A63F 13/86; A63F 13/52; A63F 13/533; A63F 13/77; G06T 5/70; G06V 20/41; G06T 2207/10016

(57) ABSTRACT

In various examples, automatic enhancement of highlights for content streaming systems and applications is described herein. Systems and methods are disclosed that automatically enhance highlights associated with applications, such as by using one or more enhancement effects, and then perform different operations using the enhanced highlights. For instance, such as during a session of the application, image data representing one or more frames (e.g., a video) associated with a highlight of the application may be obtained. The image data may then be processed to generate one or more masks associated with the frame(s). Additionally, the mask(s) may be used to add content to the frame(s), remove content from the frame(s), update content associated with the frame(s), replace content associated with the frame(s), and/or perform any other type of enhancement. After enhancing the highlight, one or more operations associated with the enhanced highlight may then be performed.

### BACKGROUND

Users of gaming applications often want to share highlights of their gaming sessions with other users. For example, if an event occurs with respect to a gaming application, such as a user accomplishing a task (e.g., completing a level, defeating a specific character, obtaining a special item, etc.), then the user may want to share a video clip that depicts the occurrence of the event with friends. In some circumstances, when sharing these highlights, the users may also want to enhance the highlights by adding, removing, and/or updating different aspects of the highlights. As such, systems may provide the highlights to the users after the gaming sessions are complete, where the users are then able to manually provide inputs indicating the types of enhancement effects that the users want to apply to the highlights. After the enhancement effects are applied, the systems may then share the enhanced highlights, such as by posting the enhanced highlights on content sharing platforms.

While such systems do allow for enhancements of gaming highlights, these systems also require that the users manually enhance the highlights as a postprocess to the gaming sessions. Because of this, users are not able to share their highlights during the gaming sessions, which may be when most other users are interested in viewing the highlights. Additionally, these systems that allow for users to enhance the highlights are separate from both the application servers that provide the gaming applications as well as the client devices that are presenting the content associated with the gaming applications. This may also increase the amount of time that it takes to generate and/or share the enhanced highlights, and/or may increase the amount of computing resources (e.g., network resources, processing resources, memory resources, etc.) that are required to generate and/or share the enhanced highlights.

### SUMMARY

Embodiments of the present disclosure relate to automatic enhancement of highlights for content streaming systems and applications. Systems and methods are disclosed that automatically enhance highlights associated with applications, such as by using one or more processing effects, and then perform different operations using the enhanced highlights. For instance, such as during a session of an application, image data representing one or more frames (e.g., a video) associated with a highlight of the application may be obtained. The image data may then be processed to generate one or more masks associated with the frame(s). As described herein, a mask may be associated with an object represented by at least one frame and/or other portion of at least one frame that is to be an enhancement. For instance, the mask(s) may be used to add content to the frame(s), remove content from the frame(s), update content associated with the frame(s), replace content associated with the frame(s), update visual characteristics associated with the frame(s), and/or perform any other type of enhancement. The enhanced highlight may then be stored in one or more memories, provided to a user for review and/or further enhancement, and/or shared with other users (e.g., during the session).

In contrast to conventional systems, such as the conventional systems described above, the systems of the present disclosure may automatically enhance highlights associated with applications, such as gaming applications, either during and/or after sessions associated with the applications. As such, the current systems may not require any inputs from users either during or after the sessions when enhancing and/or sharing the highlights, which may decrease the amount of time between when the highlights are generated for the applications and then the enhanced highlights are shared to other users. Additionally, and as described in more detail herein, the systems of the present disclosure that perform the enhancements may be associated with one or more applications servers that are streaming the applications and/or one or more client devices that are providing (e.g., presenting, rendering, etc.) the applications to users. This way, the highlights may be enhanced without requiring a separate system that is remote from the application server(s) and/or the client device(s), which may also reduce the amount of time between when the highlights are generated and/or shared, and/or may reduce the amount of computing resources required to enhance highlights.

### BRIEF DESCRIPTION OF THE DRAWINGS

The present systems and methods for automatic enhancement of highlights for content streaming systems and applications are described in detail below with reference to the attached drawing figures, wherein:

FIG. 1 illustrates an example data flow diagram for a process of automatically enhancing highlights associated with an application, in accordance with some embodiments of the present disclosure;

FIG. 2 illustrates an example of a frame that may be included as at least part of a highlight associated with a gaming application, in accordance with some embodiments of the present disclosure;

FIG. 3 illustrates an example of classifying objects represented by a frame of a highlight, in accordance with some embodiments of the present disclosure;

FIGS. 4A-4D illustrate examples of generating masks associated with a frame of a highlight, in accordance with some embodiments of the present disclosure;

FIGS. 5A-5D illustrate examples of enhancing a frame of a highlight using various processing effects, in accordance with some embodiments of the present disclosure;

FIG. 6 illustrates an example data flow diagram for a process of performing one or more operations using enhanced highlights, in accordance with some embodiments of the present disclosure;

FIG. 7 illustrates a flow diagram showing a method for enhancing a highlight during a session associated with an application, in accordance with some embodiments of the present disclosure;

FIG. 8 illustrates a flow diagram showing a method for enhancing a highlight using one or more configurations, in accordance with some embodiments of the present disclosure;

FIG. 9 is a block diagram of an example content streaming system suitable for use in implementing some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed related to automatic enhancement of highlights for content streaming systems and applications. For instance, such as during a session associated with an application, a system(s) may receive data (referred to, in some examples, as “application data”) associated with the application that is being streamed between one or more application servers and one or more client devices. As described herein, the application data may include, but is not limited to, image data representing one or more frames being presented using the client device(s), audio data representing one or more sounds being output using the client device(s), input data representing one or more inputs received using the client device(s), user data representing information associated with the user(s) (e.g., one or more enhancement preferences of the user(s), a history of one or more previous enhancements made by the user(s), etc.), and/or any other type of data associated with the application. In some examples, the system(s) may include and/or be part of the application server(s) that is streaming content data (e.g., the image data, the audio data, etc.) to the client device(s). In some examples, the system(s) may include and/or be part of the client device(s) that is providing (e.g., presenting, rendering, etc.) content represented by the content data to the user(s). Still, in some examples, the system(s) may be remote from, and/or communicate with, the application server(s) and/or the client device(s).

The system(s) may also obtain, receive, retrieve, generate, and/or store data (referred to, in some examples, as “configuration data”) associated with enhancing highlights corresponding to the application. For instance, the configuration data may represent one or more types of processing effects for enhancing highlights, which are described in more detail herein. In some examples, the system(s) may generate the configuration data using input data received from the client device(s), such as input data representing the type(s) of processing effect(s). In some examples, the system(s) may generate the configuration data using history data associated with the user(s), such as history data representing one or more past enhancements performed by the user(s) for one or more previous highlights. Still, in some examples, the system(s) may generate the configuration data to include one or more general processing effects that the system(s) uses for enhancing highlights for multiple users and/or multiple applications. While these are just a few example techniques of how the system(s) may generate the configuration data, in other examples, the system(s) may use additional and/or alternative techniques and/or data to generate the configuration data.

The system(s) may then use at least a portion of the application data to generate one or more highlights associated with the application. As described herein, a highlight may include, but is not limited to, a frame represented by the image data, a video (e.g., multiple frames) represented by the image data, sound represented by the audio data, and/or any other type of content represented by the application data. In some examples, the system(s) may determine to generate a highlight based at least on the occurrence of one or more detected events. As described herein, a detected event may include, but is not limited to, an input from the user(s) to generate the highlight, an event occurring with regard to the application (e.g., finishing a level, defeating another character, obtaining a special item, etc.), the application providing an instruction to generate the highlight, a time period elapsing, and/or any other detected event. Based at least on the system(s) determining to generate the highlight, the system(s) may retrieve and/or store the image data representing the frame(s) associated with the highlight (and/or other type of data representing another type of content associated with the highlight).

To enhance the highlight, and for a frame represented by the image data, the system(s) may process the frame using one or more machine learning models, one or more neural networks, one or more algorithms, one or more modules, and/or any other component that is configured to perform object segmentation, object classification, object detection, and/or any other image processing technique. For instance, based at least on the processing, the system(s) may determine classifications associated with different objects represented by the frame. As described herein, in some examples, a classification associated with an object may include, but is not limited to, character, structure, item, vehicle, animal, on screen display (OSD), ground surface, background, and/or any other classification associated with any other type of object. Additionally, a classification may be associated with a sub-classification, such as main character, friendly character, unfriendly character, teammate, partner, and/or the like associated with the classification for characters.

The system(s) may then use one or more of the classifications and/or at least a portion of the configuration data to generate one or more masks associated with enhancing the frame. For instance, and as described in more detail herein, the system(s) may generate a mask that represents a portion the frame associated with an object, a mask that represents a portion of the frame associated with an object along with an area surrounding the object, a mask that represents a specific portion of the frame (e.g., a middle portion, a corner portion, an edge portion, etc.), and/or a mask that represents any other portion of the frame. In some examples, the system(s) may represent a mask using one or more techniques, such as one or more locations of one or more vertices and/or points associated with the mask. For a first example, if a mask includes a rectangular shape, then the system(s) may represent the mask using a first two-dimensional (2D) location of a first point (e.g., a first pixel) associated with a first vertex of the rectangle and a second 2D location of a second point (e.g., a second pixel) associated with a second, opposite vertex of the rectangle. For a second example, if a mask includes an oval shape, then the system(s) may represent the mask using 2D locations of points (e.g., pixels) included within the mask. For a third example, if a mask includes an irregular shape, then the system(s) may represent the mask using a sufficient number of 2D locations of points (e.g., pixels) included within the mask.

The system(s) may then use one or more of the masks to enhance at least a portion of the frame, such as by using the type(s) of processing effect(s) represented by the configuration data. For a first example of enhancing the frame using a first type of processing effect (e.g., a first enhancement effect), the system(s) may use the mask(s) to determine one or more portions of the frame that are associated with one or more specific objects, such as one or more OSDs. The system(s) may then update content of the frame that is associated with the portion(s) of the frame. For instance, the system(s) may remove the content (e.g., the object(s), such as the OSD(s)) located within the portion(s) of the frame, replace the content located within the portion(s) of the frame with new content, update one or more visual characteristics (e.g., pixels colors, resolution, contrast, brightness, etc.) associated with the content located within the portion(s) of the frame, and/or perform any other content updating technique.

For a second example of enhancing the frame using a second type of processing effect (e.g., a second enhancement effect), the system(s) may use the mask(s) to determine a portion of the frame that is associated with an area of interest. As described herein, in some examples, the area of interest may include an object along with an area that at least partially surrounds the object, multiple objects along with an area that is at least between the objects, a specific area of the frame (e.g., the middle of the frame, a corner of the frame, an edge of the frame, etc.), and/or any other area of the frame. The system(s) may then update content of the frame that is located outside of the portion of the frame that is associated with the area of interest. For instance, the system(s) may remove the content, replace the content with new content, update one or more visual characteristics (e.g., pixels colors, resolution, contrast, brightness, etc.) associated with the content, and/or perform any other content updating technique.

For a third example of enhancing a frame using a third type of processing effect (e.g., a third enhancement effect), the system(s) may use the mask(s) to determine a portion of the frame that is associated with a specific object. The system(s) may then update content of the frame that is associated with a background to the specific object. For instance, the system(s) may update the background to include a new (e.g., alternative) background. While these are just a few examples of processing effects that the system(s) may use to enhance the frame, in other examples, the system(s) may enhance the frame using additional and/or alternative processing effects and/or the system(s) may enhance the frame using more than one type of processing effect.

The system(s) may then use one or more additional processes when enhancing the highlight, such as when the highlight is associated with multiple frames. For instance, in some examples, the system(s) may perform one or more processes techniques in order to ensure that the enhancements are compatible across the frames of the highlight, such as one or smoothing techniques, one or more alignment techniques, one or more content matching techniques, and/or any other processing technique. Additionally, or alternatively, in some examples, the system(s) may again combine the frames such that the frames again represent a video associated with the highlight. As will be described in more detail herein, the system(s) may perform one or more of these additional processes when enhancing the highlight since the system(s) may enhance individual frames of the highlight independently even though the highlight includes a video consisting of multiple of the frames. For example, the system(s) may enhance a first frame of the highlight, followed by a second frame of the highlight, followed by a third frame of the highlight, and/or so forth in subsequent order.

The system(s) may then perform one or more operations using the enhanced highlight. For instance, the system(s) may store the enhanced highlight (e.g., the image data representing the frame(s) of the highlight) in one or more memories, cause the enhanced highlight to be shared with one or more other users (e.g., post the enhanced highlight on one or more online resources), provide the enhanced highlight to the user(s) for performing additional enhancement, and/or perform any other operation. Additionally, the system(s) may continue to perform these processes to continue generating and/or enhancing one or more additional highlights associated with the application.

As described herein, in some examples, the system(s) may perform at least a portion of these processes for enhancing the highlight(s) during the session associated with the application. This way, the system(s) is able to reduce the amount of time it takes to perform the operation(s) associated with the highlight(s), such as sharing the enhanced highlight(s) with other users, when compared to conventional systems that provide highlights. Additionally, the system(s) may perform at least a portion of these processes with no and/or little input from the user(s) (e.g., just using input indicating the processing effect(s) for performing the enhancement, which may be provided before the session associated with the application begins), which may also reduce the amount of time it takes to perform the operation(s) as compared to the conventional systems. Furthermore, the system(s) that performs the enhancements may be included as part of the application server(s) and/or the client device(s), which may save computing resources as compared to the conventional systems that are separate from the application server(s) and/or the client device(s).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more visual language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

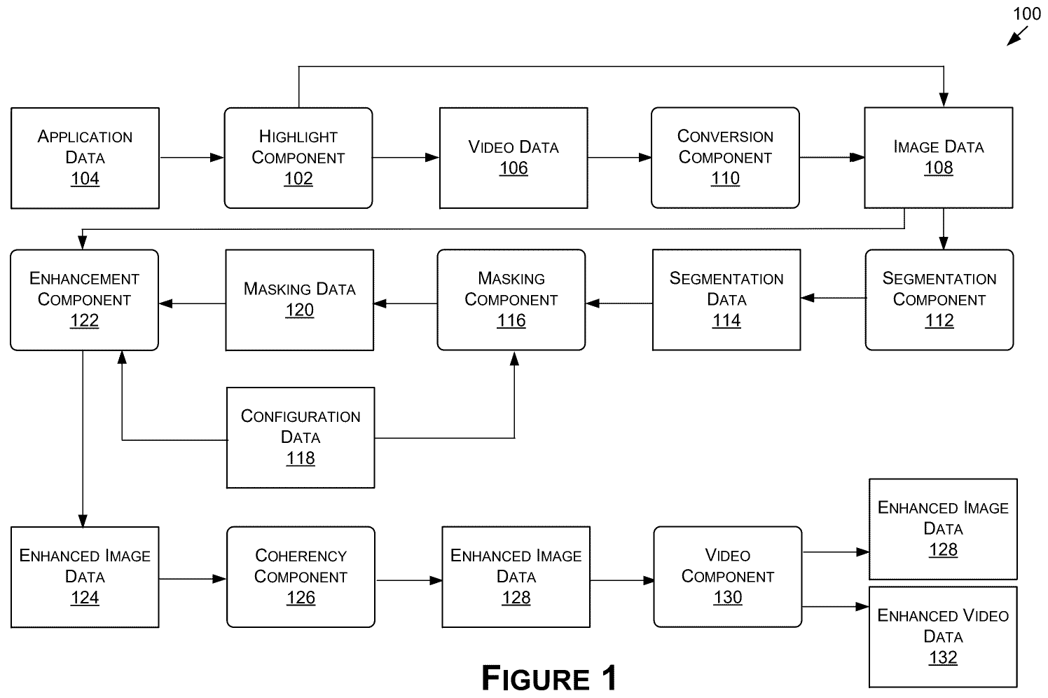

With reference to FIG. 1, FIG. 1 illustrates an example data flow diagram for a process 100 of automatically enhancing highlights associated with an application, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

For instance, the process 100 may include a highlight component 102 receiving application data 104 associated with an application. For instance, such as during a session associated with an application, the highlight component 102 may receive the application data 104 associated with the application that is being streamed between one or more application servers (e.g., the application server(s) 902) and one or more client devices (e.g., the client device(s) 904). As described herein, the application may be, include, and/or be included as a feature of, without limitation, a gaming application, an interactive application, a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, or any other type of application. Additionally, application data 104 may include, but is not limited to, image data representing one or more frames, audio data representing one or more sounds, input data representing one or more user inputs, user data representing information associated with one or more users, and/or any other type of data associated with the application.

The process 100 may then include the highlight component 102 using at least a portion of the application data 104 to generate one or more highlights associated with the application. As described herein, a highlight may include, but is not limited to, video data 106 representing a video (e.g., multiple frames) associated with the application, image data 108 representing a single frame associated with the application, audio data representing sound associated with the application, and/or any other type of data representing any other type of content associated with the application. Additionally, the highlight component 102 may determine to generate a highlight based at least on the occurrence of one or more events. For example, the highlight component 102 may determine to generate a highlight based at least on a user input representing a request to generate the highlight, an event that occurs with respect to the application, a time period elapsing, the application indicating to generate a highlight, and/or any other event. In some examples, an event occurring with respect to the application may include, but is not limited to, a user completing a level, completing a specific task, reaching a specific point, finding another character, defeating another character, obtaining a specific item, identifying a specific location, winning a match, winning a tournament, setting a record score, and/or any other type of event that may occur with respect to the application.

In some examples, such as when the highlight component 102 generates the video data 106 representing the video associated with a highlight, the process 100 may include a conversion component 110 converting the video into individual frames, where the individual frames may also be represented by the image data 108. For instance, and as described herein, the video may include any length video, such as a 5 second video, a 10 second video, a 15 second video, a 30 second video, and/or any other length video. Additionally, the frame rate of the video may include any frame rate, such as 15 frames per second (FPS), 30 FPS, 60 FPS, 120 FPS, 240 FPS, and/or any other frame rate. As such, the conversion component 110 may convert the video into its individual frames. For example, if the video includes a length of 15 seconds and a frame rate of 240 FPS, then the conversion component 110 may generate the image data 108 to represent 3,600 frames.

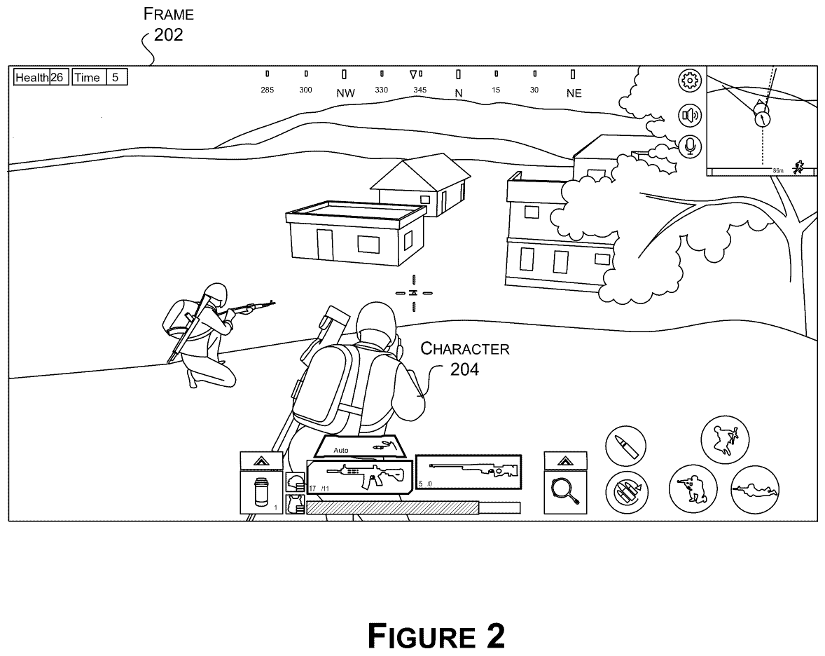

For instance, FIG. 2 illustrates an example of a frame 202 that may be included as at least part of a highlight associated with a gaming application, in accordance with some embodiments of the present disclosure. In the example of FIG. 2, the highlight may be associated with an occurrence of an event, such as a main character 204 reaching a specific point within the gaming application. As such, in some examples, the highlight component 102 may generate image data (e.g., the image data 108) representing the frame 202. However, in other examples, the highlight component 102 may generate video data (e.g., the video data 106) representing a video that includes at least the frame 202 representing the event along with one or more frames that precede the frame 202 and/or one or more frames that are subsequent to the frame 202. The conversion component 110 may then convert the video into the individual frames, including the frame 202, to generate image data representing the frames.

Referring back to the example of FIG. 1, the process 100 may include using a segmentation component 112 to process at least a portion of the image data 108 to perform object segmentation, object classification, object detection, and/or any other type of classification technique. As described herein, the segmentation component 112 may process the image data 108 using one or more machine learning models, one or more neural networks, one or more algorithms, one or more modules, and/or any other type of processing component. In some examples, the processing component used by the segmentation component 112 may include a general processing component that the segmentation component 112 uses to process data associated with multiple applications. In some examples, the processing component used by the segmentation component 112 may include a custom processing component (e.g., a fine-tuned model, a trained model, etc.) that the segmentation component 112 uses to process data from this specific application. For instance, the processing component may be trained to classify objects that are associated with the application, such as by using additional application data associated with the application.

For an example of processing a frame, the segmentation component 112 may process the frame in order to classify points (e.g., pixels, groups of pixels, etc.) of the frame. As described herein, a classification associated with a point may indicate an object for which the point represents. For instance, the segmentation component 112 may classify one or more first points as being associated with a main character, one or more second points as being associated with another character, one or more third points as being associated with an OSD, one or more fourth points as being associated with a background, and/or so forth. In some examples, the segmentation component 112 may then use the classifications to group the points in order to identify the locations of objects represented by the frame. For instance, the segmentation component 112 may group the first point(s) as being associated with the main character, the second point(s) as being associated with the other character, the third point(s) as being associated with the OSD, the fourth point(s) as being associated with the background, and/or so forth.

The process 100 may then include the segmentation component 112 generating and/or outputting segmentation data 114 associated with the segmentations and/or classifications. For instance, and for a frame, the segmentation data 114 may represent locations of the points within the frame, locations of the objects represented by the frame, the classifications associated with the points of the frame, the classifications associated with the objects represented by the frame, and/or any other segmentation, detection, and/or classification information. As described herein, a location of a point may include a 2D location, such as the x-coordinate location and the y-coordinate location of the point within the frame, and/or any other type of location associated with the point of the frame. The segmentation component 112 may then perform similar processes to generate segmentation data 114 for one or more additional frames represented by the image data 108. For example, the segmentation component 112 may perform similar processes to generate respective segmentation data 114 for each frame represented by the image data 108.

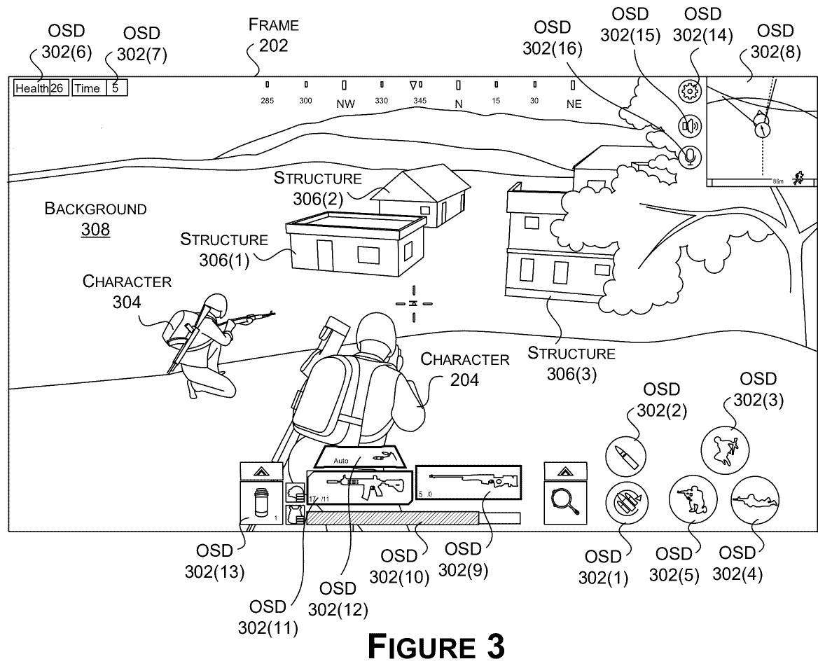

For instance, FIG. 3 illustrates an example of classifying objects represented by the frame 202 of the gaming application, in accordance with some embodiments of the present disclosure. As shown, the segmentation component 112 may perform one or more of the processes described herein to classify at least the character 204, OSDs 302(1)-(16) (also referred to singularly as “OSD 302” or in plural as “OSDs 302”), another character 304, structures 306(1)-(3) (also referred to singularly as “structure 306” or in plural as “structures 306”), and a background 308. While the example of FIG. 3 illustrates classifying these specific objects using these specific classifications, in other examples, the segmentation component 112 may classify additional and/or alternative objects represented by the frame 202 and/or may classify the objects using additional and/or alternative classifications.

The segmentation component 112 may then generate and/or output data (e.g., the segmentation data 114) representing information associated with the segmentation and/or classification. For instance, the data may represent at least the locations of the objects within the frame 202, the classifications associated with the objects, and/or any other information. For example, and with regard to at least the main character 204, the data may represent the 2D locations of the points (e.g., the pixels) that are associated with the main character 204 along with the classification associated with the main character 204, which may include “main character,” “user character,” and/or any other type of classifications that identifies the main character 204.

Referring back to the example of FIG. 1, the process 100 may include using a masking component 116 to generate one or more masks associated with the frame(s) using at least the segmentation data 114 and/or configuration data 118, where the configuration data 118 may represent at least one or more types of processing effects for enhancing highlights. As described herein, in some examples, the configuration data 118 may include general configuration data 118 that is used to enhance highlights for one or more applications and/or one or more users, such as by using the same type(s) of processing effect(s). In some examples, the configuration data 118 may include custom configuration data 118 that is used to enhance highlights for the application and/or the user(s). For example, the configuration data 118 may be generated using input data representing one or more inputs from the user(s) that indicate one or more type of processing effects to use to enhance highlights, history data representing one or more previous types of processing effects that the user(s) used to enhance highlights, preference data representing one or more types of processing effects that the user(s) prefers when generating highlights, and/or any other data associated with the user(s).

Additionally, as described herein, in some examples, an enhancement effect for a highlight may include, but is not limited to, removing content from one or more frames of the highlight, adding content to one or more frames of the highlight, updating content from one or more frames of the highlight, replacing content from one or more frames of the highlight, updating one or more visual characteristics (e.g., pixels colors, resolution, contrast, brightness, etc.) associated with one or more frames of the highlight, and/or performing any other type of enhancement associated with one or more frames of the highlight. As such, the masking component 116 may use the configuration data 118 to determine one or more masks to generate in order to enhance a highlight.

For instance, and for a frame of a highlight, the masking component 116 may generate a mask that represents a portion the frame associated with an object, a mask that represents a portion of the frame associated with an object along with an area at least partially surrounding the object, a mask that represents a specific portion of the frame (e.g., an area of interest, such as a middle portion, a corner portion, an edge portion etc.), and/or a mask that represents any other portion of the frame. In some examples, the masking component 116 may represent a mask using one or more techniques, such as one or more locations of one or more vertices and/or points associated with the mask. For a first example, if a mask includes rectangular shape, then the masking component 116 may represent the mask using at least a first 2D location (e.g., the x-coordinate location and the y-coordinate location) for a first point (e.g., a first pixel) associated with a first vertex of the mask and a second 2D location (e.g., the x-coordinate location and the y-coordinate location) of a second point (e.g., a second pixel) associated with a second, opposite vertex of the mask. For a second examples, if a mask includes an oval shape, then the masking component 116 may represent the mask using 2D locations (e.g., the x-coordinate locations and the y-coordinate locations) associated with points (e.g., pixels) that are included within the mask.

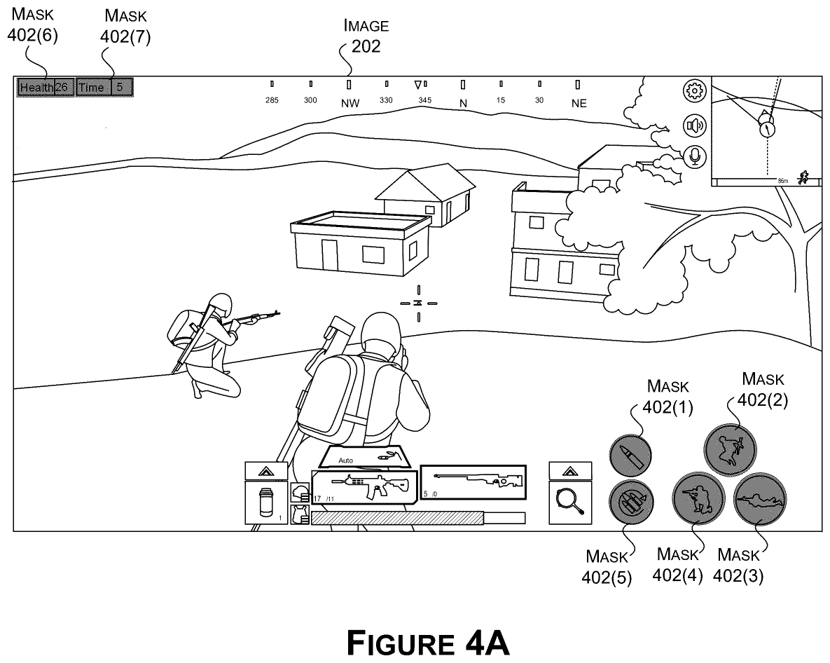

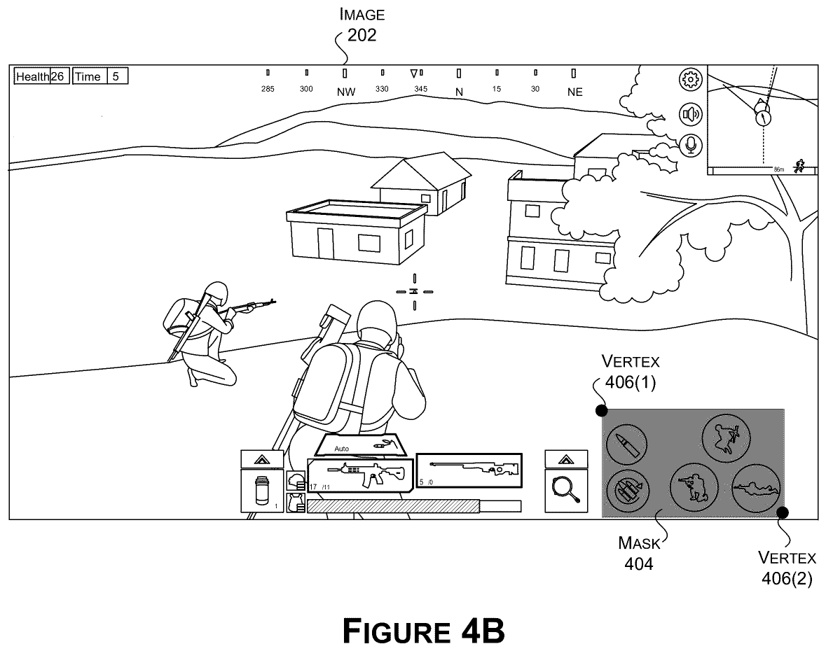

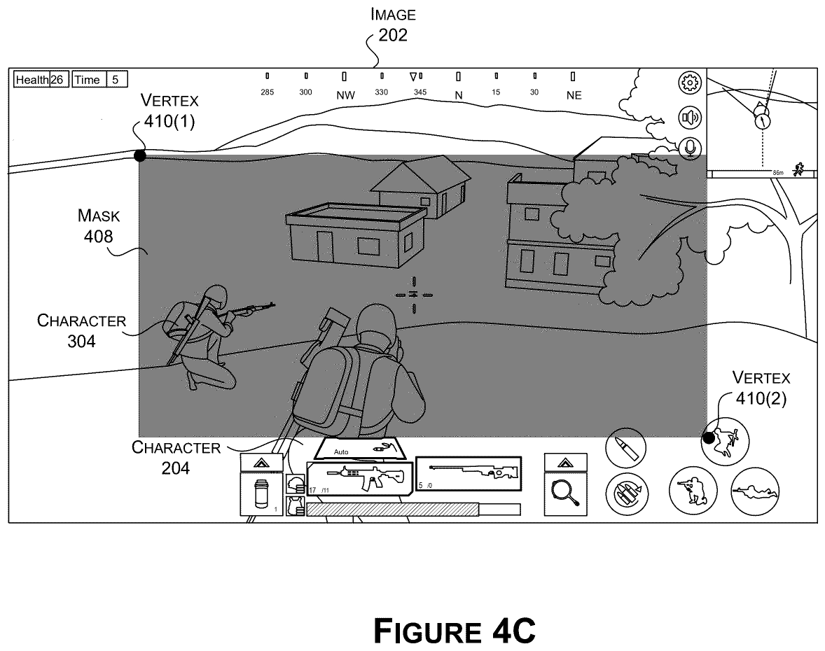

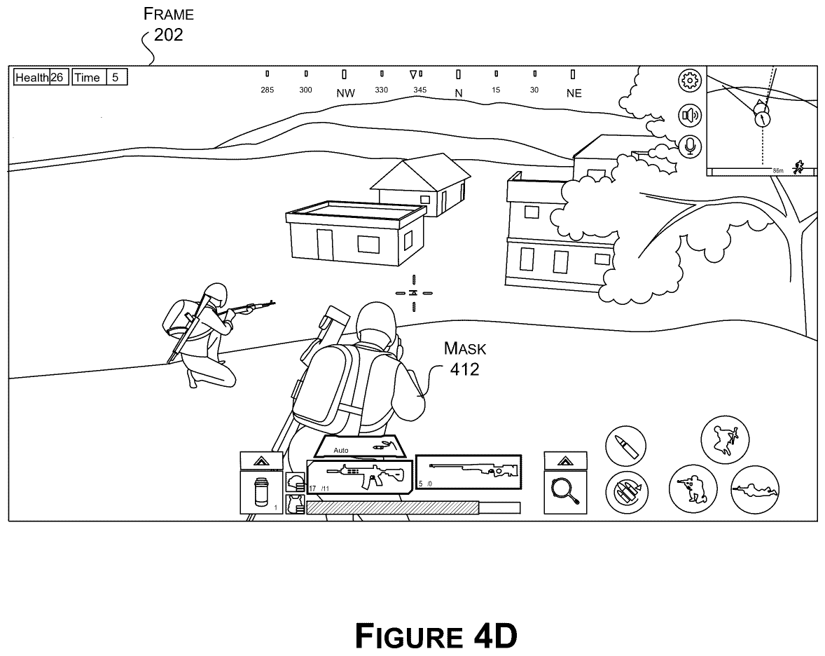

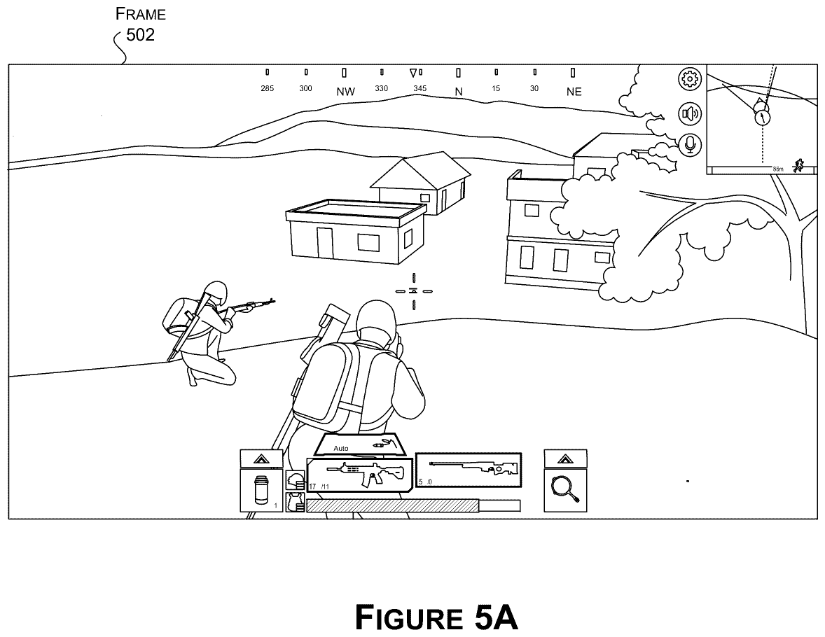

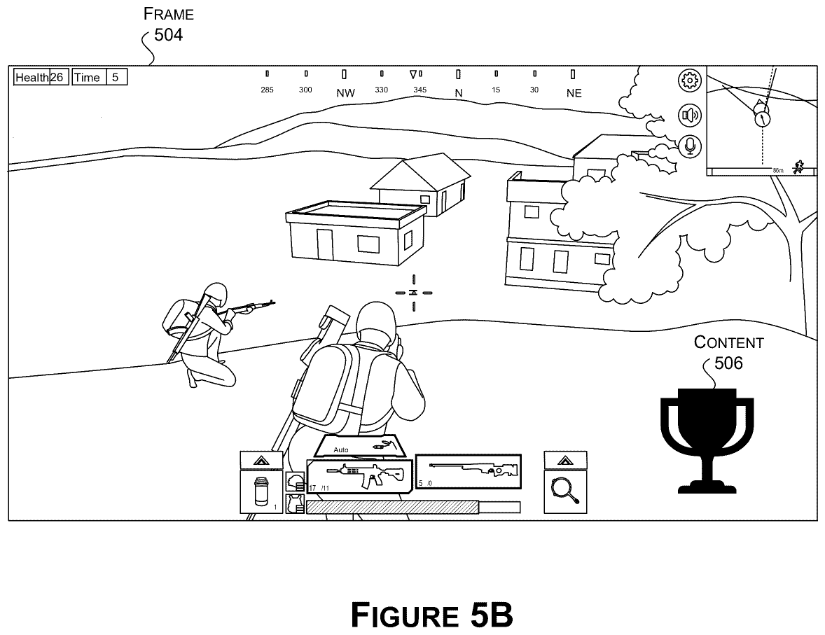

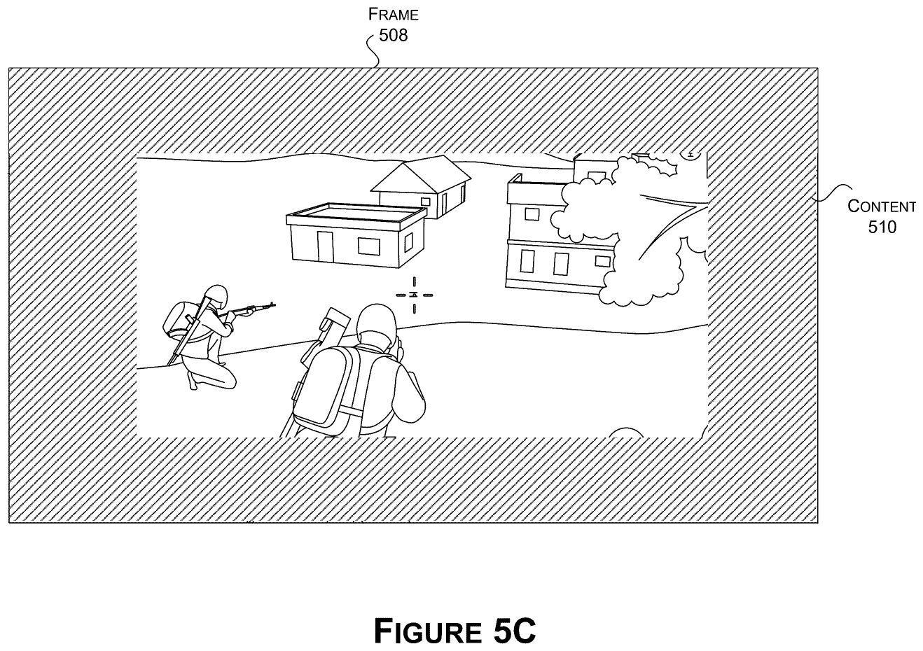

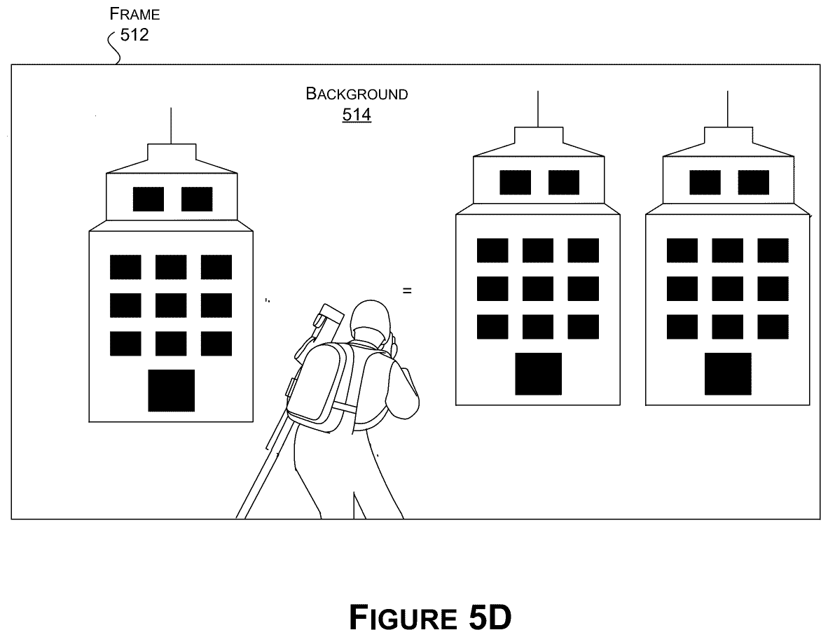

For instance, FIGS. 4A-4D illustrate examples of generating masks associated with the frame 202, in accordance with some embodiments of the present disclosure. As shown by the example of FIG. 4A, the masking component 116 may generate masks 402(1)-(7) (also referred to singularly as “mask 402” or in plural as “masks 402”) representing portions of the frame 202 that are associated with one or more specific types of content, such as the OSDs 302(1)-(7) that are to be removed when performing an enhancement associated with the frame 202 (which is illustrated by the example of FIG. 5A), where the masks 402 are indicated by grey shading. While the example of FIG. 4A illustrates generating the masks 402 for only a portion of the OSDs 302(1)-(7), in other examples, the masking component 116 may generate a respective mask for each of the OSDs 302 included within the frame 202. The masking component 116 may then generate data representing locations of the masks 402 using one or more techniques. For example, and for a mask 402, the masking component 116 may generate data representing 2D locations of points (e.g., pixels) that are associated with (e.g., included within) the mask 402.

As shown by the example of FIG. 4B, the masking component 116 may generate a mask 404 representing a portion of the frame 202 that is again associated with one or more specific types of content, such as the OSDs 302(1)-(5) that are to be replaced with additional content when performing an enhancement associated with the frame 202 (which is illustrated by the example of FIG. 5B), where the mask 404 is again indicated by grey shading. The masking component 116 may then generate data representing a location of the mask 404 using one or more techniques. For a first example, the masking component 116 may generate data representing at least a first 2D location associated with a first vertex 406(1) of the mask 404 and a second 2D location associated with a second vertex 406(2) of the mask 404. For a second example, the masking component 116 may generate data representing 2D locations of points (e.g., pixels) that are associated with (e.g., included within) the mask 404.

As shown by the example of FIG. 4C, the masking component 116 may generate a mask 408 that is associated with a portion of the frame 202 that includes content that is to be unchanged when performing an enhancement associated with the frame 202 (which is illustrated by the example of FIG. 5C), where the mask 408 is again indicated by grey shading. While the example of FIG. 4C illustrates the mask 408 as including a rectangle shape and being located substantially at a center of the frame 202, in other examples, the mask 408 may include any other shape (e.g., a circle shape, an oval shape, a pentagon shape, an irregular shape, etc.) and/or be located at any other location of the frame 202. Additionally, in some examples, the masking component 116 may determine the shape and/or location of the mask 408 such that the mask 408 includes specific content. For instance, and in the example of FIG. 4C, the masking component 116 may determine the shape and/or location of the mask 408 such that the mask 408 includes characters (e.g., the character 204 and the character 304) that are important to the user(s).

The masking component 116 may then generate data representing a location of the mask 408 using one or more techniques. For a first example, the masking component 116 may generate data representing at least a first 2D location associated with a first vertex 410(1) of the mask 408 and a second 2D location associated with a second vertex 410(2) of the mask 408. For a second example, the masking component 116 may generate data representing 2D locations of points (e.g., pixels) that are associated with (e.g., included within) the mask 408.

As shown by the example of FIG. 4D, the masking component 116 may generate a mask 412 that is associated with a specific object, such as the character 204, that represents content that is to be unchanged when performing an enhancement of the frame 202 (which is illustrated by the example of FIG. 5D), where the mask 412 is just indicated by the character 204 in this example. The masking component 116 may then generate data representing a location of the mask 412 using one or more techniques. For example, the masking component 116 may generate data representing 2D locations of points (e.g., pixels) that are associated with (e.g., included within) the mask 412. While the examples of FIGS. 4A-4D illustrate a few example techniques of generating masks for the frame 202 that are later used for enhancement of the frame 202, in other examples, the masking component 116 may generate additional and/or alternative masks associated with enhancing the frame 202.

Referring back to the example of FIG. 1, the process 100 may include the masking component 116 generating and/or outputting masking data 120 representing the mask(s) associated with the frame(s) represented by the image data 108. For instance, in some examples, and for a mask, the masking data 120 may represent or include at least an identifier associated with the mask, an identifier associated with a frame for which the mask is associated, a location of the mask (e.g., using one or more of the techniques described herein) within the frame, and/or any other information associated with the mask. In some examples, the masking component 116 may generate and/or output respective masking data 120 for multiple frames. For example, the masking component 116 may generate and/or output respective masking data 116 for each frame represented by the image data 108.

The process 100 may include an enhancement component 122 using at least a portion of the configuration data 118 and/or at least a portion of the masking data 120 to enhance at least a portion of the frame(s) represented by the image data 108. For instance, and for a frame, the enhancement component 122 may use the configuration data 118 to determine a type of processing effect to perform in order to enhance the frame. As described herein, in some examples, the type of processing effect may include, but is not limited to, removing content from the frame, adding content to frame, updating content (e.g., one or more visual characteristics) of the frame, replacing content of the frame, and/or performing any other type of enhancement associated with frame. Additionally, for the frame, the enhancement component 122 may use the masking component 116 to identify the content that is to be removed, the content that is to be updated, the content that is to be replaced, and/or the portion(s) of the frame for adding new content.

For a first example of enhancing a frame using a first type processing effect (e.g., a first enhancement effect), the enhancement component 122 may use one or more masks to determine one or more portions of the frame that are associated with one or more specific objects, such as one or more OSDs. The enhancement component 122 may then update content of the frame that is associated with the portion(s) of the frame. For instance, the enhancement component 122 may remove the content (e.g., the object(s), such as the OSD(s)) located within the portion(s) of the frame, replace the content located within the portion(s) of the frame with new content, update one or more visual characteristics (e.g., pixels colors, resolution, contrast, brightness, etc.) associated with the content located within the portion(s) of the frame, and/or perform any other content updating technique.

For a second example of enhancing a frame using a second type of processing effect (e.g., a second enhancement effect), the enhancement component 122 may use one or more masks to determine a portion of the frame that is associated with an area of interest. As described herein, in some examples, the area of interest may include an object along with an area that at least partially surrounds the object, multiple objects along with an area that is at least between the objects, a specific area of the frame (e.g., the middle of the frame, a corner of the frame, an edge of the frame, etc.), and/or any other area of the frame. The enhancement component 122 may then update content of the frame that is located outside of the portion of the frame that is associated with the area of interest. For instance, the enhancement component 122 may remove the content that is located outside of the area of interest, replace the content that is located outside of the area of interest, update one or more visual characteristics (e.g., pixels colors, resolution, contrast, brightness, etc.) associated with the content that is located outside of the area of interest, and/or perform any other content updating technique.

For a third example of enhancing a frame using a third type of processing effect (e.g., a third enhancement effect), the enhancement component 122 may use one or more masks to determine one or more portions of the frame that are associated with one or more specific objects, such as a main character (and/or any other object). The enhancement component 122 may then update content of the frame that is located outside of the portion(s) of the frame that is associated with the specific object(s). For instance, the enhancement component 122 may remove the content that is located outside of the portion(s) of the frame, replace the content that is located outside of the portion(s) of the frame, update one or more visual characteristics (e.g., pixels colors, resolution, contrast, brightness, etc.) associated with the content that is located outside of the portion(s) of the frame, and/or perform any other content updating technique. While these are just a few examples of processing effects that the enhancement component 122 may use to enhance frames, in other examples, the enhancement component 122 may enhance frames using additional and/or alternative processing effects.

For instance, FIGS. 5A-5D illustrate examples of enhancing the frame 202 using various processing effects, in accordance with some embodiments of the present disclosure. As shown by the example of FIG. 5A, the enhancement component 122 may use configuration data (e.g., the configuration data 118) to determine that the processing effect includes removing content from the frame 202. Additionally, the enhancement component 122 may use masking data (e.g., the masking data 120) representing the masks 402 to identify the content to be removed, such as the OSDs 302(1)-(7) in the example of FIG. 5A. As such, the enhancement component 122 may then generate an enhanced frame 502 by removing the OSDs 302(1)-(7) from the frame 202. While the example of FIG. 5A only illustrates removing a portion of the OSDs 302 from the frame 202, in other examples, the enhancement component 122 may perform similar processes to remove all of the OSDs 302 from the frame 202.

As shown by the example of FIG. 5B, the enhancement component 122 may use configuration data (e.g., the configuration data 118) to determine that the processing effect includes replacing content included in the frame 202. Additionally, the enhancement component 122 may use masking data (e.g., the masking data 120) representing the mask 404 to identify the content to be replaced, such as the OSDs 302(1)-(5) in the example of FIG. 5B. As such, the enhancement component 122 may then generate an enhanced frame 504 by replacing the OSDs 302(1)-(5) from the frame 202 with content 506. While the example of FIG. 5B illustrates the content 506 as include a trophy, in other examples, the enhancement component 122 may replace the OSDs 302(1)-(5) with any other type of content.

As shown by the example of FIG. 5C, the enhancement component 122 may use configuration data (e.g., the configuration data 118) to determine that the processing effect includes updating content included in the frame 202. Additionally, the enhancement component 122 may use masking data (e.g., the masking data 120) representing the mask 408 to identify the content to replace, such as the content that is located outside of the mask 408. As such, the enhancement component 122 may then generate an enhanced frame 508 by updating the content from the frame 202 with updated content 510. In some examples, the enhancement component 122 may update the content by updating visual characteristics, such as pixel values, associated with the content. While the example of FIG. 5C illustrates the updated content 510 as including a constant pattern, in other examples, the updated content may include any other type of content (e.g., matching pixels to the input content).

As shown by the example of FIG. 5D, the enhancement component 122 may use configuration data (e.g., the configuration data 118) to determine that the processing effect includes updating the background 308 associated with the frame 202. Additionally, the enhancement component 122 may use masking data (e.g., the masking data 120) representing the mask 412 to identify the portion of the frame 202 that includes the background 308, such as the portion of the frame 202 other than the portion that includes the main character 204 associated with the mask 412. As such, the enhancement component 122 may then generate an enhanced frame 512 by replacing the original background of the frame 202 with a new background 514 (e.g., new content). While the example of FIG. 5D illustrates the new background 514 as including a city, in other examples, the new background may include any other type of background (e.g., a dessert, a forest, a farm, etc.).

Referring back to the example of FIG. 1, in some examples, the enhancement component 122 may perform similar processes to enhance each of the frame(s) of the highlight. In some examples, the enhancement component 122 may perform similar processes to enhance only a portion of the frame(s) of the highlight. Still, in some examples, the enhancement component 122 may perform similar processes to enhance the frame(s) using the same processing effect while, in other examples, the enhancement component 122 may perform similar processes to enhance the frame(s) using various processing effects. In any of the examples, the process 100 may then include the enhancement component 122 generating and/or outputting enhanced image data 124 representing the enhanced frame(s) of the highlight.

The process 100 may include a coherency component 126 processing at least a portion of the enhanced image data 124 in order to ensure that the enhancements are compatible across the frame(s) of the highlight. As described herein, in some examples, the coherency component 126 may perform one or more techniques to ensure that the enhancements are compatible, such as one or more smoothness techniques, one or more alignment techniques, one or more content matching techniques, and/or so forth. For a first example, if a processing effect that is associated with enhancing a highlight includes removing OSDs from the frames, then the coherency component 126 may determine that the enhancements are compatible when one or more (e.g., all) of the frames include the same OSDs removed or determine that the enhancements are not compatible when one or more frames include different OSDs removed as compared to one or more other frames.

For a second example, if a processing effect that is associated enhancing a highlight includes updating content that is located outside of an area of interest associated with the highlight, then the coherency component 126 may determine that the enhancements are compatible when one or more (e.g., all) of the frames include the same area of interest or determine that the enhancements are not compatible when one or more frames include one or more different areas of interest as compared to one or more other frames. For a third example, if a processing effect that is associated with enhancing a highlight includes updating a background associated with the highlight, then the coherency component 126 may determine that the enhancements are compatible when one or more (e.g., all) of the frames include the same updated background or determine that the enhancements are not compatible when one or more of the frames include one or more updated backgrounds that different from one or more other frames. While these are just a few example techniques of how the coherency component 126 may determine whether enhancements are compatible across frames of a highlight, in other examples, the coherency component 126 may perform additional and/or alternative techniques to determine whether the enhancements are compatible across the frames of the highlight.

In some examples, the coherency component 126 may update one or more of the enhancements of one or more frames of a highlight based at least on determining whether the frames are compatible. For instance, if the coherency component 126 determines that the enhancements are not compatible for one or more reasons, then the coherency component 126 may update one or more of the enhancements in order to cause the enhancements to be compatible. For a first example, if the coherency component 126 determines that frames of a highlight do not include the same OSDs removed, then the coherency component 126 may update one or more enhancements of one or more of the frames such that the frames include the same OSDs removed. For a second example, if the coherency component 126 determines that frames of a highlight do not include the same area of interest, then the coherency component 126 may update one or more enhancements of one or more of the frames such that the frames include the same area of interest. For a third example, if the coherency component 126 determines that frames of a highlight do not include the same updated background, then the coherency component 126 may update one or more enhancements of one or more of the frames such that the frames include the same background.

While these are just a few example techniques of how the coherency component 126 may update enhancements in order to cause the enhancements to be compatible, in other examples, the coherency component 126 may update the enhancements using one or more additional and/or alternative techniques. Additionally, the coherency component 126 may then generate and/or output enhanced image data 128 representing the enhanced frame(s) of the highlight, where the enhanced frame(s) is compatible with one another.

In some examples, such as when the highlight includes multiple frames, the process 100 may include a video component 130 processing the enhanced image data 128 in order to generate enhanced video data 132 representing an enhanced video of the highlight. For instance, the video component 130 may generate the enhanced video data 132 by combining the frames represented by the enhanced image data 128 together. Additionally, in some examples, when combining the frames together, the video component 130 may combine the frames using the same temporal order as the original video represented by the video data 106. As such, and as shown, the video component 130 may either output the enhanced image data 128, such as when the highlight includes a single frame, or output the enhanced video data 132, such as when the highlight includes multiple frames.

As described herein, at least a portion of the process 100 may be performed by one or more application servers (e.g., the application server(s) 902), one or more client devices (e.g., the client device(s) 904), and/or any other computing device. For a first example, the client device(s) may include the highlight component 102, the conversion component 110, the segmentation component 112, the masking component 116, the enhancement component 122, the coherency component 126, and/or the video component 130. For a second example, the application server(s) may include the highlight component 102, the conversion component 110, the segmentation component 112, the masking component 116, the enhancement component 122, the coherency component 126, and/or the video component 130. Still, for a third example, the highlight component 102, the conversion component 110, the segmentation component 112, the masking component 116, the enhancement component 122, the coherency component 126, and/or the video component 130 may split between the client device(s) and the application server(s).

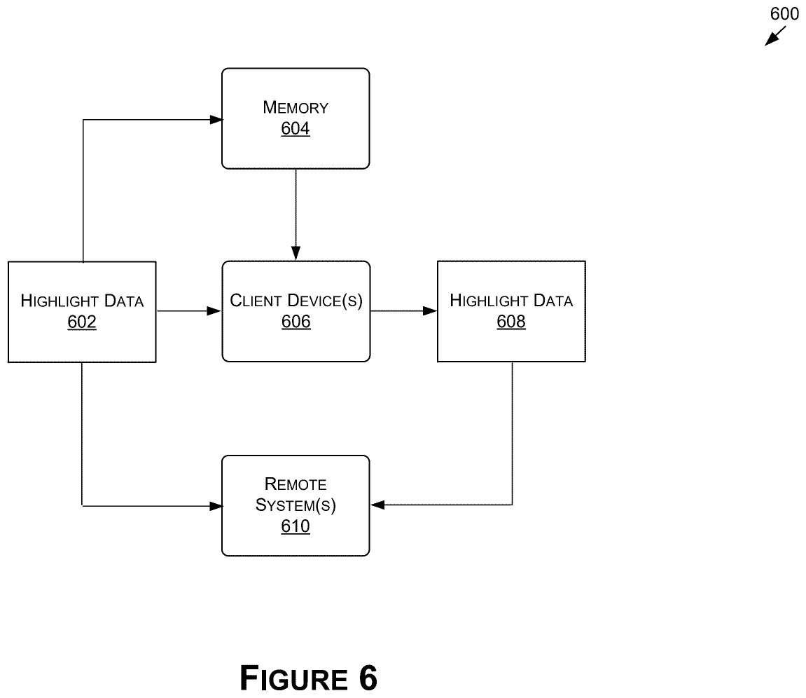

As described herein, after generating the enhanced highlight, one or more processes may be performed with respect to the enhanced highlight. For instance, FIG. 6 illustrates an example data flow diagram for a process 600 of performing one or more operations using enhanced highlights, in accordance with some embodiments of the present disclosure. As shown, in some examples, highlight data 602, which may represent and/or include the enhanced image data 128 and/or the enhanced video data 132, may be stored in one or more memories 604, such as during the session associated with the application and/or after the session associated with the application. In such examples, the highlight data 602 may then be accessible to one or more computing devices, such as one or more client devices 606 (which may represent, and/or include, the client device(s) 904) and/or one or more application servers (e.g., the application server(s) 902). For instance, in some examples, the memory 604 may be included as part of the client device(s) 606 and/or the application server(s).

Additionally, or alternatively, in some examples, the highlight data 602 may be provided to the client device(s) 606, such as during the session associated with the application and/or after the session associated with the application. In such examples, the user(s) may use the client device(s) 606 to view the enhanced highlight, cause a sharing associated with the enhanced highlight, and/or cause one or more additional enhancements associated with the enhanced highlight. As described herein, the user(s) may further enhance the enhanced highlight using one or more techniques, such as adding content, removing content, updating content, replacing content, updating visual characteristics (e.g., a brightness, a contrast, a resolution, etc.), and/or performing any other enhancements associated with the highlight. Based at least on the additional enhancements, the client device(s) 606 may generate and/or output highlight data 608 representing the highlight (e.g., the frame(s)) as further enhanced.

Additionally, or alternatively, in some examples, the highlight data 602 and/or the highlight data 608 may be provided to one or more remote systems 610 for sharing, such as during the session associated with the application and/or after the session associated with the application. As described herein, the remote system(s) 610 may share the highlight by posting the highlight on one or more resources (e.g., websites, forums, chats, etc.) that are accessible by one or more other users, sending the highlight (e.g., the highlight data 602 and/or the highlight data 608) to one or more other client devices associated with one or more other users, and/or performing any other technique. As such, and by performing the processes described with respect to FIGS. 1 and 6, the user(s) is able to more quickly share the enhanced highlight with other users, such as during the session associated with the application.

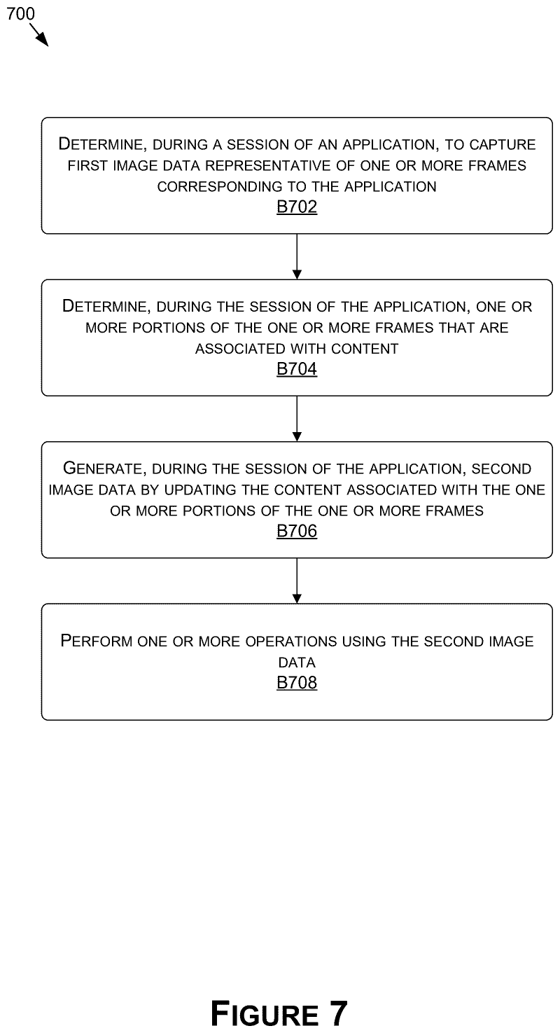

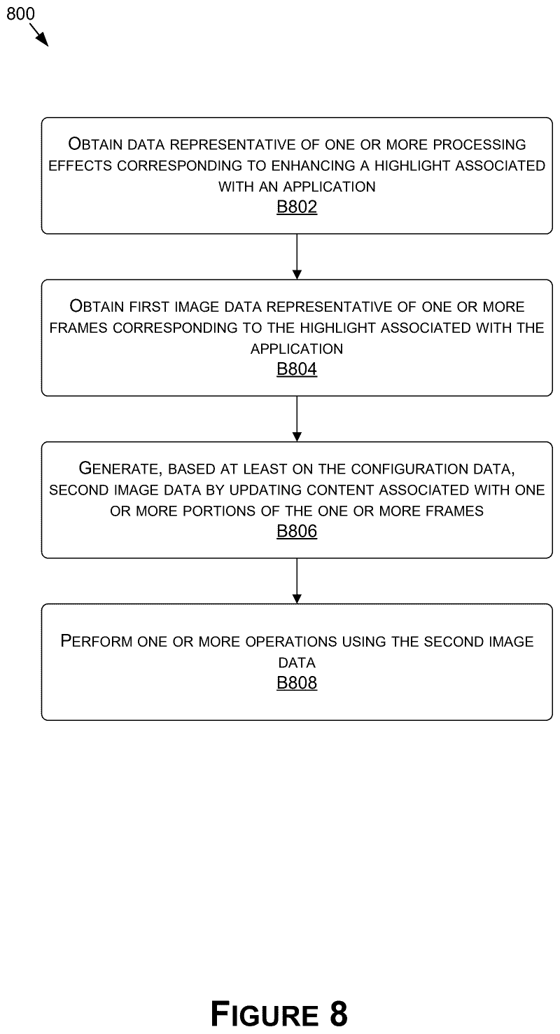

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods 700 and 800 may also be embodied as computer-usable instructions stored on computer storage media. The methods 700 and 800 may be provided by a standalone application, a service or hosted service (standalone or in combination with another hosted service), or a plug-in to another product, to name a few. In addition, the methods 700 and 800 are described, by way of example, with respect to FIG. 1. However, these methods 700 and 800 may additionally or alternatively be executed by any one system, or any combination of systems, including, but not limited to, those described herein.

FIG. 7 illustrates a flow diagram showing a method 700 for enhancing a highlight during a session associated with an application, in accordance with some embodiments of the present disclosure. The method 700, at block B702, may include determining, during a session of an application, to capture first image data representative of one or more frames corresponding to the application. For instance, the highlight component 102 may determine to capture the image data 108 representative of the frame(s). As described herein, in some examples, the highlight component 102 may determine to capture the image data 108 based at least on the occurrence of one or more events. For example, the highlight component 102 may determine to capture the image data 108 based on receiving an input from a user, based at least on the image data 108 representing an event, and/or based at least on any other event occurring.

The method 700, at block B704, may include determining, during the session of the application, one or more portions of the one or more frames that are associated with content. For instance, the segmentation component 112 may process the image data 108 in order to perform object segmentation, object classification, object detection, and/or any other type of classification technique. For example, based at least on the processing, the segmentation component 112 may determine one or more classifications associated with one or more objects represented by the frame(s). In some examples, the masking component 116 may then use the classification(s) to generate one or more masks associated with the frame(s). As described herein, in some examples, the masking component 116 may further generate the mask(s) using the configuration data 118 representing one or more processing effects to perform to enhance the frame(s).

The method 700, at block B706, may include generating, during the session of the application, second image data by updating the content associated with the one or more portions of the one or more frames. For instance, the enhancement component 122 may use the masking data 120 representing the mask(s) and/or the configuration data 118 to enhance the frame(s) represented by the image data 108. As described herein, the enhancement component 122 may perform the enhancement by updating the content, such as by removing at least a portion of the content, adding new content, replacing at least a portion of the content, updating visual characteristics associated with at least a portion of the content, and/or so forth.

The method 700, at block B708, may include performing one or more operations using the second image data. For instance, one or more operations may be performed using the enhanced image data 128 (and/or the enhanced video data 132) representing the enhanced frame(s). As described herein, the operation(s) may include, but is not limited to, storing the enhanced image data 128 in memory, providing the enhanced frame(s) to one or more users for further enhancement, sharing the enhanced frame(s) with one or more users, and/or any other operation.

FIG. 8 illustrates a flow diagram showing a method 800 for enhancing a highlight using one or more configurations, in accordance with some embodiments of the present disclosure. The method 800, at block B802, may include obtaining data representative of one or more processing effects corresponding to enhancing a highlight associated with an application. For instance, the enhancement component 122 may obtain the configuration data 118 representing the processing effect(s) associated with enhancing the highlight. As described herein, in some examples, the configuration data 118 may be associated with general users and/or general applications. However, in some examples, the configuration data 118 may be associated with one or more specific users and/or one or more specific applications. For instance, the user(s) may provide one or more inputs indicating the processing effect(s) to use when enhancing the highlight for the application.

The method 800, at block B804, may include obtaining first image data representative of one or more first frames corresponding to the highlight associated with the application. For instance, the enhancement component 122 may receive the image data 108 representing the frame(s) corresponding to the highlight associated with the application. As described herein, the enhancement component 122 may obtain the image data 108 after obtaining the configuration data 118. For instance, the highlight component 102 may determine to capture the image data 108 representative of the frame(s), such as based at least on the occurrence of one or more events, after the user(s) indicates the processing effect(s) to use when enhancing the highlights.

The method 800, at block B806, may include generating, based at least on the configuration data, second image data by updating content associated with one or more portions of the one or more frames. For instance, the enhancement component 122 may use a least the configuration data 118 to enhance the frame(s) represented by the image data 108. As described herein, the enhancement component 122 may perform the enhancement by updating the content, such as by removing at least a portion of the content, adding new content, replacing at least a portion of the content, updating visual characteristics associated with at least a portion of the content, and/or so forth. Based at least on the updating, the enhancement component 122 may generate the enhanced image data 128 (and/or the enhanced video data 132) representing the enhanced frame(s).

The method 800, at block B808, may include performing one or more operations using the second image data. For instance, one or more operations may be performed using the enhanced image data 128 (and/or the enhanced video data 132) representing the enhanced frame(s). As described herein, the operation(s) may include, but is not limited to, storing the enhanced image data 128 in memory, providing the enhanced frame(s) to one or more users for further enhancement, sharing the enhanced frame(s) with one or more users, and/or any other operation.

### Example Content Streaming System

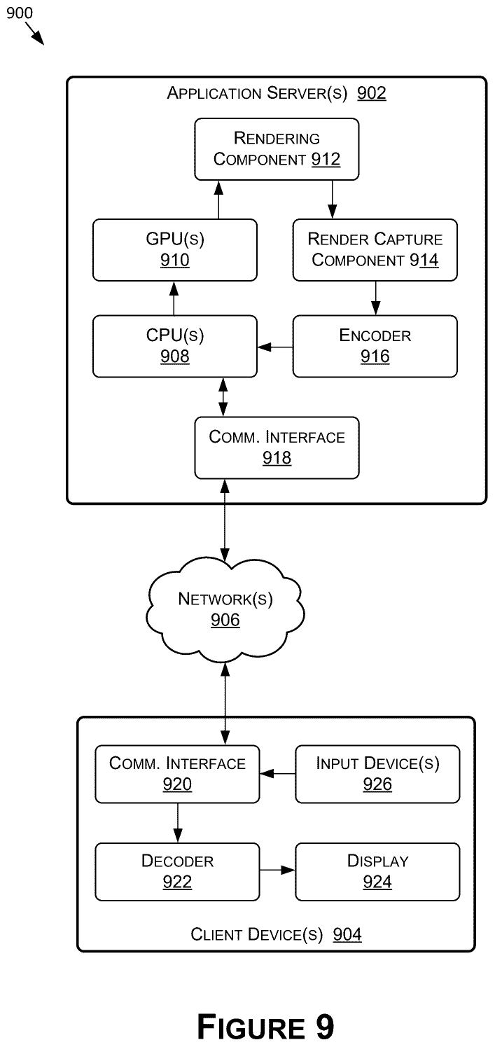

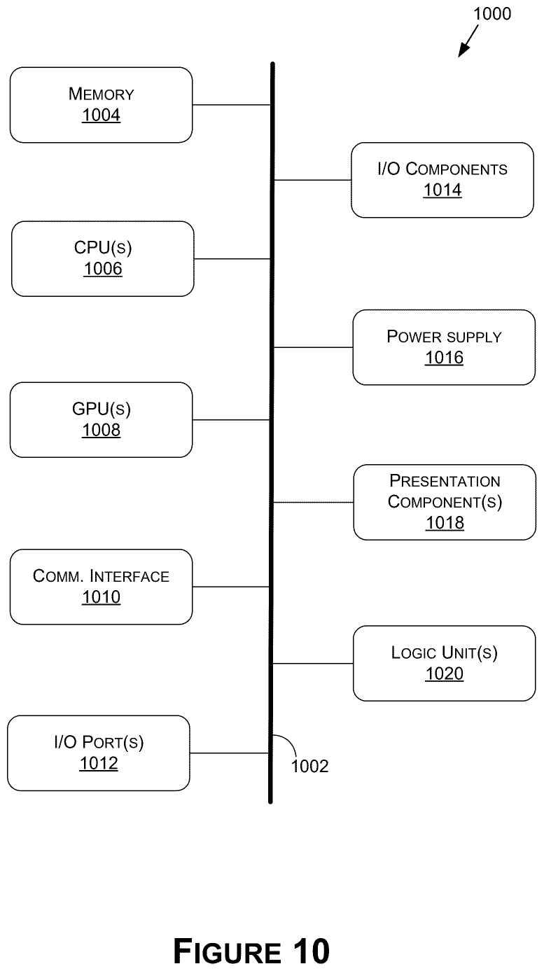

Now referring to FIG. 9, FIG. 9 is an example system diagram for a content streaming system 900, in accordance with some embodiments of the present disclosure. FIG. 9 includes application server(s) 902 (which may include similar components, features, and/or functionality to the example computing device 1000 of FIG. 10), client device(s) 904 (which may include similar components, features, and/or functionality to the example computing device 1000 of FIG. 10), and network(s) 906 (which may be similar to the network(s) described herein). In some embodiments of the present disclosure, the system 900 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 900, for an application session, the client device(s) 904 may only receive input data in response to inputs to the input device(s), transmit the input data to the application server(s) 902, receive encoded display data from the application server(s) 902, and display the display data on the display 924. As such, the more computationally intense computing and processing is offloaded to the application server(s) 902 (e.g., rendering—in particular ray or path tracing—for graphical output of the application session is executed by the GPU(s) of the game server(s) 902). In other words, the application session is streamed to the client device(s) 904 from the application server(s) 902, thereby reducing the requirements of the client device(s) 904 for graphics processing and rendering.

For example, with respect to an instantiation of an application session, a client device 904 may be displaying a frame of the application session on the display 924 based on receiving the display data from the application server(s) 902. The client device 904 may receive an input to one of the input device(s) and generate input data in response. The client device 904 may transmit the input data to the application server(s) 902 via the communication interface 920 and over the network(s) 906 (e.g., the Internet), and the application server(s) 902 may receive the input data via the communication interface 918. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 912 may render the application session (e.g., representative of the result of the input data) and the render capture component 914 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 902. In some embodiments, one or more virtual machines (VMs)—e.g., including one or more virtual components, such as vGPUs, vCPUs, etc.—may be used by the application server(s) 902 to support the application sessions. The encoder 916 may then encode the display data to generate encoded display data and the encoded display data may be transmitted to the client device 904 over the network(s) 906 via the communication interface 918. The client device 904 may receive the encoded display data via the communication interface 920 and the decoder 922 may decode the encoded display data to generate the display data. The client device 904 may then display the display data via the display 924.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

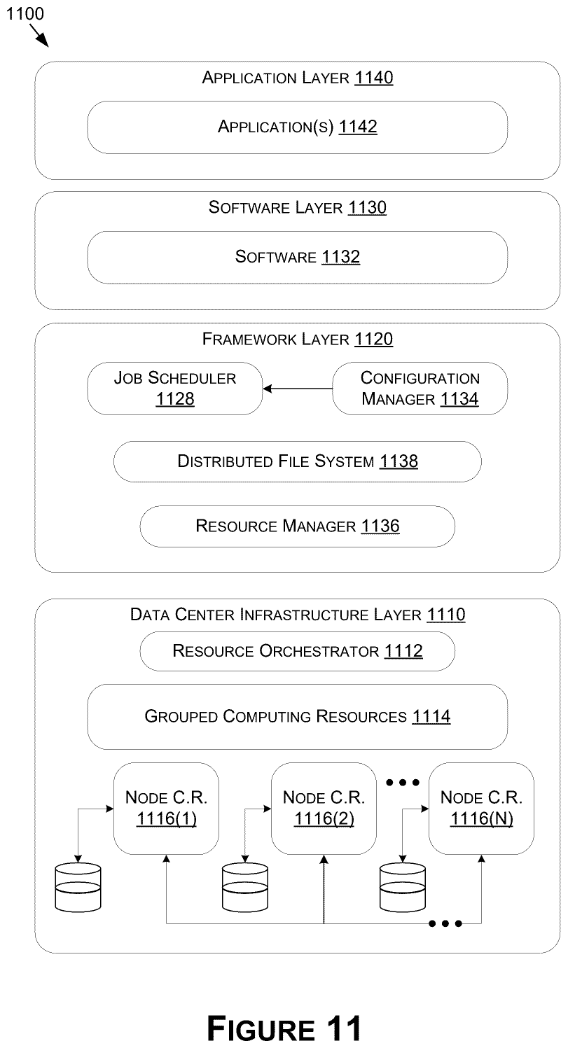

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161 (N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116 (N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: determining to capture first image data during a session of a gaming application, the first image data representative of one or more frames generated using a remote computing device during the session of the gaming application; determining, during the session of the gaming application, one or more portions of content depicted in the one or more frames; generating, during the session of the gaming application, second image data from the first image data by updating the one or more portions of content depicted in the one or more frames; and performing one or more operations using the second image data.

B: The method of paragraph A, wherein: the one or more portions of content include one or more on screen displays at least partially depicted in the one or more frames; and the generating the second image data by updating the one or more portions of content comprises generating, during the session of the gaming application, the second image data by at least one of removing the one or more screen displays from the one or more frames or replacing the one or more on screen displays on the one or more frames with second content.

C: The method of either paragraph A or paragraph B, wherein: the one or more portions of content at least partially surround one or more second portions of content depicted in the one or more frames; and the generating the second image data by updating the one or more portions of content comprises generating, during the session of the gaming application, the second image data by updating one or more visual characteristics associated with the one or more second portions of content.

D: The method of any one of paragraphs A-C, wherein: the one or more portions of content are associated with one or more first backgrounds corresponding to the one or more frames; and the generating the second image data by updating the one or more portions of content comprises generating, during the session of the gaming application, the second image data by updating the one or first backgrounds to include one or more second backgrounds.

E: The method of any one of paragraphs A-D, wherein the determining the one or more portions of content depicted in the one or more frames comprises: determining, during the session of the gaming application, one or more classifications for one or more objects depicted in the one or more frames; and determining, during the session of the gaming application and based at least on the one or more classifications, one or more masks corresponding to at least a subset of the one or more objects, the at least the subset of the one or more objects having a position within the one or more portions of content as depicted in the one or more frames.

F: The method of any one of paragraphs A-E, further comprising: receiving, at least one of before the session of the gaming application or during the session of the gaming application, configuration data representative of one or more processing effects associated with updating the one or more portions of content, wherein the generating the second image data is based at least on the configuration data.

G: The method of any one of paragraphs A-F wherein: the one or more frames comprises a plurality of frames; and the generating the second image data by updating the one or more portions of content comprises generating, during the session of the gaming application, the second image data by smoothing the one or more portions of content between the plurality of frames.

H: The method of any one of paragraphs A-G, further comprising: converting, during the session of the gaming application, the first image data into at least third image data representative of a first frame of the one or more frames and fourth image data representative of a second frame of the one or more frames; and further generating, during the session of the gaming application, the second image data by combining the first frame with the second frame after updating the one or more portions of content.

I: The method of any one of paragraphs A-H, wherein the performing of the one or more operations using the second image data comprises one or more of: storing, during the session of the gaming application, the second image data in one or more memories; causing, during the session of the gaming application and using the second image data, the one or more frames depicting the updated one or more portions of content to be shared; or causing using the second image data, a client device to present the one or more frames.

J: The method of any one of paragraphs A-I, wherein the determining to capture the first image data is based at least on at least one of: receiving input data representative of a request to capture the first image data; or determining that an event associated with the gaming application has occurred, the first image data representative of at least the event.

K: A system comprising: one or more processors to: obtain, at a first time, configuration data representative of one or more updates for content associated with a highlight; obtain, at a second time after the first time, first image data representative of one or more frames corresponding to the highlight, the first image data generated using a remote computing device during a session of the application; generate, based at least on the configuration data and from the first image data, second image data by updating at least a portion of the content associated with the one or more frames; and perform one or more operations using the second image data.

L: The system of paragraph K, wherein the one or more processors are further to: determine one or more portions of the one or more frames that correspond to one or more on screen displays, the one or more on screen displays within the at least the portion of the content, wherein the generation of the second image data by updating the at least the portion of the content comprises generating, based at least on the configuration data, the second image by at least one of removing the one or more screen displays from the one or more frames or replacing the one or more on screen displays on the one or more frames with second content.

M: The system of either paragraph K or paragraph L, wherein the one or more processors are further to: determine one or more first portions of the one or more frames that at least partially surround one or more second portions of the one or more frames, wherein the generation of the second image data by updating the at least the portion of the content comprises generating, based at least on the configuration data, the second image data by updating the at least the portion of the content included in the one or more first portions of the one or more frames with second content.

N: The system of any one of paragraphs K-M, wherein the one or more processors are further to: determine one or more first portions of the one or more frames corresponding to at least an object and one or more second portions of the one or more frames corresponding to at least a first background associated with the object, wherein the generation of the second image data by updating the at least the portion of the content comprises generating, based at least on the configuration data, the second image data by updating the first background within the one or more frames with a second background.

O: The system of any one of paragraphs K-N, wherein the one or more processors are further to: determine one or more classifications for one or more objects represented by the one or more images; and generate one or more masks based at least on the one or more classifications, wherein the generation of the second image data is further based at least on the one or more masks.

P: The system of any one of paragraphs K-O, wherein the one or more processors are further to: receive, from one or more client devices, input data representative of the one or more updates for the content associated with the highlight, wherein the configuration data is generated based at least on the input data.

Q: The system of any one of paragraphs K-P, wherein the generation of the second image data further comprises at least one of: applying a smoothing associated with the updating of the at least the portion of the content associated with the one or more frames; or generating a video by combining the one or more frames as updated.

R: The system of any one of paragraphs K-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to generate, during a session associated with a streaming application, image data representing a highlight associated with the streaming application based at least on updating content associated with one or more frames corresponding to the highlight, and perform one or more operations associated with the image data.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining to capture first image data during a session of a gaming application, the first image data representative of one or more frames generated using a remote computing device during the session of the gaming application;
determining, during the session of the gaming application, one or more portions of content depicted in the one or more frames;
generating, during the session of the gaming application, second image data from the first image data by updating the one or more portions of content depicted in the one or more frames; and
performing one or more operations using the second image data.

2. The method of claim 1, wherein:
the one or more portions of content include one or more on screen displays at least partially depicted in the one or more frames; and
the generating the second image data by updating the one or more portions of content comprises generating, during the session of the gaming application, the second image data by at least one of removing the one or more screen displays from the one or more frames or replacing the one or more on screen displays on the one or more frames with second content.

3. The method of claim 1, wherein:
the one or more portions of content at least partially surround one or more second portions of content depicted in the one or more frames; and
the generating the second image data by updating the one or more portions of content comprises generating, during the session of the gaming application, the second image data by updating one or more visual characteristics associated with the one or more second portions of content.

4. The method of claim 1, wherein:
the one or more portions of content are associated with one or more first backgrounds corresponding to the one or more frames; and
the generating the second image data by updating the one or more portions of content comprises generating, during the session of the gaming application, the second image data by updating the one or first backgrounds to include one or more second backgrounds.

5. The method of claim 1, wherein the determining the one or more portions of content depicted in the one or more frames comprises:
determining, during the session of the gaming application, one or more classifications for one or more objects depicted in the one or more frames; and
determining, during the session of the gaming application and based at least on the one or more classifications, one or more masks corresponding to at least a subset of the one or more objects, the at least the subset of the one or more objects having a position within the one or more portions of content as depicted in the one or more frames.

6. The method of claim 1, further comprising:
receiving, at least one of before the session of the gaming application or during the session of the gaming application, configuration data representative of one or more processing effects associated with updating the one or more portions of content, wherein the generating the second image data is based at least on the configuration data.

7. The method of claim 1, wherein:
the one or more frames comprises a plurality of frames; and
the generating the second image data by updating the one or more portions of content comprises generating, during the session of the gaming application, the second image data by smoothing the one or more portions of content between the plurality of frames.

8. The method of claim 1, further comprising:
converting, during the session of the gaming application, the first image data into at least third image data representative of a first frame of the one or more frames and fourth image data representative of a second frame of the one or more frames; and
further generating, during the session of the gaming application, the second image data by combining the first frame with the second frame after updating the one or more portions of content.

9. The method of claim 1, wherein the performing of the one or more operations using the second image data comprises one or more of:
storing, during the session of the gaming application, the second image data in one or more memories;
causing, during the session of the gaming application and using the second image data, the one or more frames depicting the updated one or more portions of content to be shared; or
causing using the second image data, a client device to present the one or more frames.

10. The method of claim 1, wherein the determining to capture the first image data is based at least on at least one of:
receiving input data representative of a request to capture the first image data; or
determining that an event associated with the gaming application has occurred, the first image data representative of at least the event.

11. A system comprising:
one or more processors to:
obtain, at a first time, configuration data representative of one or more updates for content associated with a highlight;
obtain, at a second time after the first time, first image data representative of one or more frames corresponding to the highlight, the first image data generated using a remote computing device during a session of the application;
generate, based at least on the configuration data and from the first image data, second image data by updating at least a portion of the content associated with the one or more frames; and
perform one or more operations using the second image data.

12. The system of claim 11, wherein the one or more processors are further to:
determine one or more portions of the one or more frames that correspond to one or more on screen displays, the one or more on screen displays within the at least the portion of the content,
wherein the generation of the second image data by updating the at least the portion of the content comprises generating, based at least on the configuration data, the second image by at least one of removing the one or more screen displays from the one or more frames or replacing the one or more on screen displays on the one or more frames with second content.

13. The system of claim 11, wherein the one or more processors are further to:
determine one or more first portions of the one or more frames that at least partially surround one or more second portions of the one or more frames,
wherein the generation of the second image data by updating the at least the portion of the content comprises generating, based at least on the configuration data, the second image data by updating the at least the portion of the content included in the one or more first portions of the one or more frames with second content.

14. The system of claim 11, wherein the one or more processors are further to:
determine one or more first portions of the one or more frames corresponding to at least an object and one or more second portions of the one or more frames corresponding to at least a first background associated with the object,
wherein the generation of the second image data by updating the at least the portion of the content comprises generating, based at least on the configuration data, the second image data by updating the first background within the one or more frames with a second background.

15. The system of claim 11, wherein the one or more processors are further to:
determine one or more classifications for one or more objects represented by the one or more images; and
generate one or more masks based at least on the one or more classifications,
wherein the generation of the second image data is further based at least on the one or more masks.

16. The system of claim 11, wherein the one or more processors are further to:
receive, from one or more client devices, input data representative of the one or more updates for the content associated with the highlight,
wherein the configuration data is generated based at least on the input data.

17. The system of claim 11, wherein the generation of the second image data further comprises at least one of:
applying a smoothing associated with the updating of the at least the portion of the content associated with the one or more frames; or
generating a video by combining the one or more frames as updated.

18. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to generate, during a session associated with a streaming application, image data representing a highlight associated with the streaming application based at least on updating content associated with one or more frames corresponding to the highlight, and perform one or more operations associated with the image data.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
